(19) United States
(12) Patent Application Publication
(10) Pub. No.: US 2018/0186158 A1
(43) Pub. Date: Jul. 5, 2018

(54) PRINTHEAD TANGENT ADJUSTMENT MECHANISM

(71) Applicant: AVERY DENNISON RETAIL INFORMATION SERVICES, LLC, Mentor, OH (US)

(72) Inventors: Joshua J. Blauvelt, Erin, NY (US); Donald J. Ward, Sayre, PA (US); Jason R. Wheeler, Sayre, PA (US)

(21) Appl. No.: 15/857,806

(22) Filed: Dec. 29, 2017

Related U.S. Application Data
(60) Provisional application No. 62/440,586, filed on Dec. 30, 2016.

(51) Int. Cl. B41J 25/308; B41J 11/20; B41J 11/04; B41J 11/00; B41J 2/32

(52) U.S. Cl. CPC B41J 25/308; B41J 11/20; B41J 2202/31; B41J 11/0035; B41J 2/32; B41J 11/04

(57) ABSTRACT

A printer comprising an assembly for adjusting a printhead and a platen roller. The assembly comprises a first bracket for engaging the printhead, and a second bracket for engaging the platen roller. The first bracket slideably engages the second bracket. The assembly further comprises a positioning element attached to the second bracket, and an adjusting element operated by a camshaft to slide the second bracket across the first bracket, thereby optimizing a distance between the printhead and the platen roller to accommodate media of varying thickness and stiffness.

### CROSS REFERENCE TO RELATED APPLICATION(S)

The present application claims priority to and the benefit of U.S. Provisional Application No. 62/440,586 filed Dec. 30, 2016, which is incorporated herein by reference in its entirety.

### BACKGROUND

The present invention relates generally to a printer utilizing an assembly for adjusting a printhead. More particularly, the present disclosure relates to an assembly for tangentially adjusting a printhead with respect to a platen roller and, depending on the thickness of a receiver material, to provide an optimal alignment of the platen roller to a dot line on the printhead.

Thermal print technology is a contact printing process. The printing depends on aligning a dot line with a platen roller which can vary depending on the specific characteristics of a particular receiver type. Existing thermal printers can print on an assortment of different receiver types such as receipt paper, fabric, laminated labels, cardstock, and the like. However, due to the varying stiffness properties of the different receivers, as well as the thickness of the receiver, the optimal tangent point on the center line of the platen roller to the dot line on the thermal printhead can be at different physical locations. Traditional methods of adjusting this difference in locations permit the operator of the printer to unintentionally misalign the tangent point on the center line of the platen roller with the dot line on the thermal printhead. This accidental misalignment reduces the overall quality of the printing job.

Thermal printheads are used in thermal printers where they produce dots of heat in order to form an image on thermal sensitive media. The dots of heat are aligned in a single line called the dot line. The media used in these printers has either a direct thermal coating on a receiver or a thermal transfer ribbon and a receiver. The media is pressed against the printhead so that heat can flow into the media. The printer uses a platen roller to press the media against the printhead. There is an optimum position to press the platen roller onto the dot line of the printhead that varies with respect to the thickness and stiffness of the receiver.

Thus, there exists a need for an adjustable assembly for optimizing the alignment of a platen roller and a printhead. The present invention discloses an improved printer employing an adjustable assembly for adjusting the distance between a printhead and a platen roller. The assembly does not require the use of any external tools to adjust the distance. More specifically, the present invention discloses an assembly that utilizes two parts to allow the printhead to be adjusted in the media path direction in both directions from the standard controlled print position.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a printer comprising a housing, a platen roller, a printhead, and an assembly for adjusting the position of the printhead with respect to the position of the platen roller. The assembly comprises a first bracket for engaging the printhead, and a second bracket for engaging the platen roller. The position of the first bracket is adjustable with respect to the position of the second bracket.

In a preferred embodiment, the assembly further comprises a positioning element attached to the second bracket and an adjusting element for engaging the positioning element. The adjusting element is rotatably engaged by a camshaft. As the adjusting element rotates, it engages the positioning element to move the second bracket laterally across the first bracket. The movement of the second bracket across the first bracket adjusts the distance between the printhead and the platen roller, thereby allowing a user to optimize the print position depending on the thickness of the receiver material.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a diagrammatic view of a printer opened to reveal internal components of the printer, including a printhead adjustment assembly in accordance with the disclosed architecture.

FIG. 2 illustrates a front view of a printhead for the printer in accordance with the disclosed architecture.

FIG. 3 illustrates a front perspective view of a platen roller of the printer in accordance with the disclosed architecture.

FIG. 4 illustrates a front partially exploded view of the printhead adjustment assembly in accordance with the disclosed architecture.

FIG. 5 illustrates a front perspective view of a second bracket of the printhead adjustment assembly in accordance with the disclosed architecture.

FIG. 6 illustrates an top view of a position indicator for the printhead adjustment assembly in accordance with the disclosed architecture.

FIG. 7 illustrates a front perspective view of a roll of a receiver material for use with the printer in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

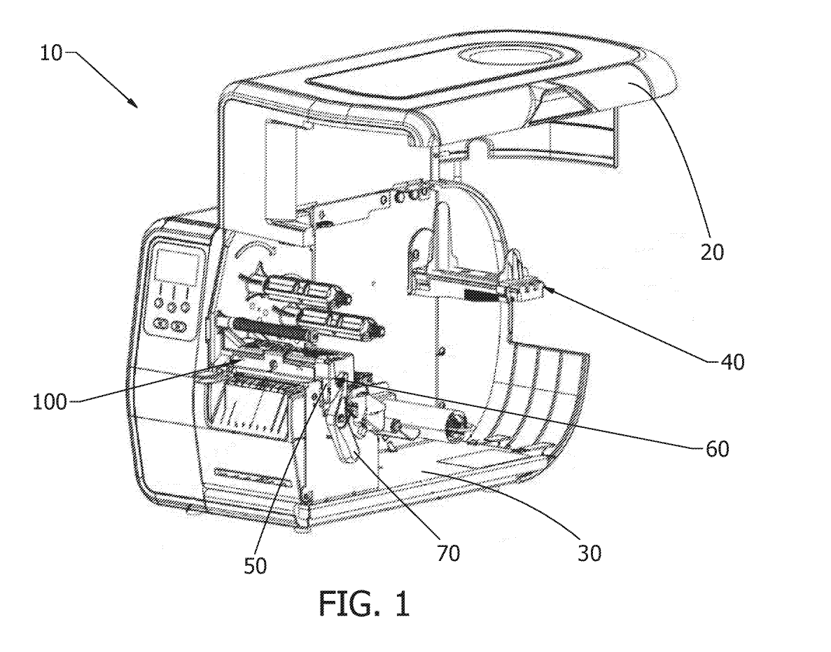

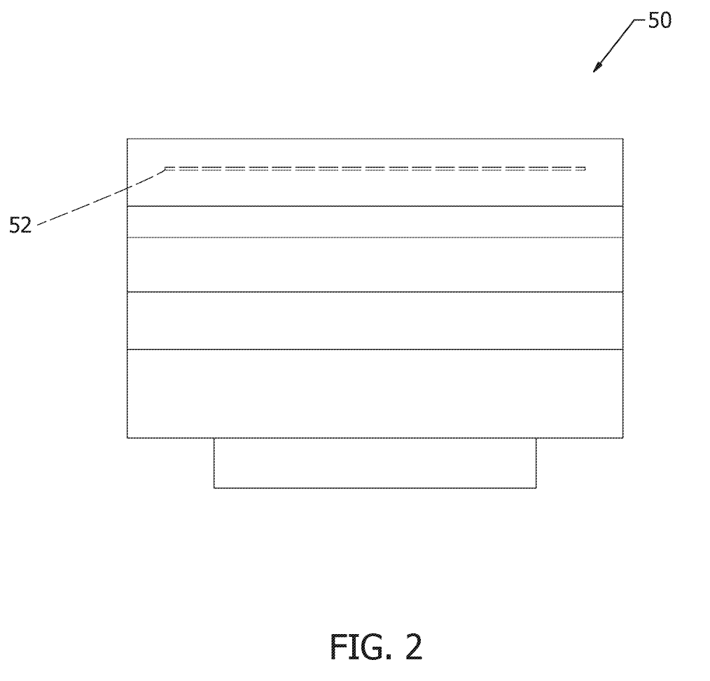

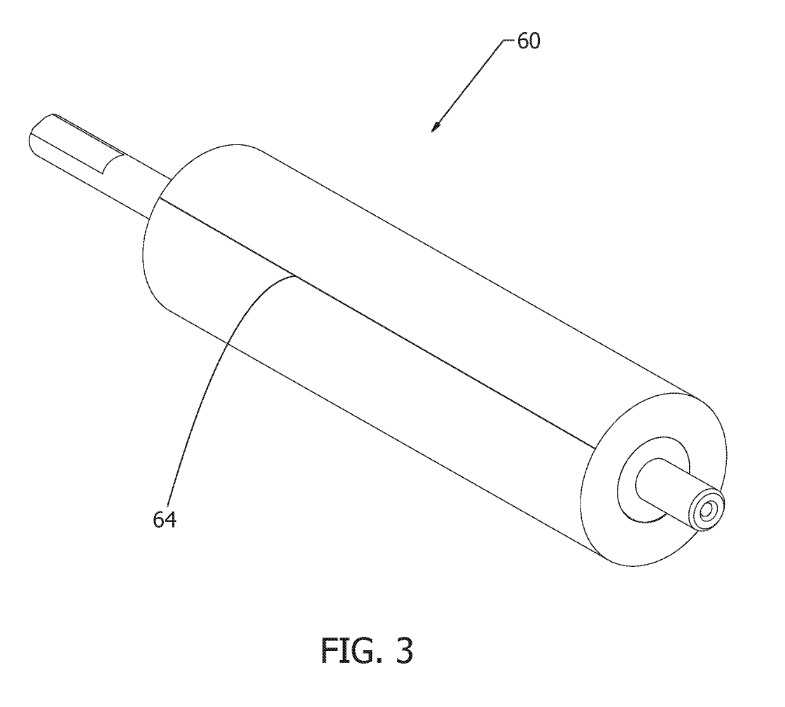

Referring initially to the drawings, FIG. 1 illustrates a printer 10 utilizing an assembly 100 for tangentially adjusting a printhead 50 in accordance with the present invention. Assembly 100 is used to improve the print quality of media of varying thickness and stiffness. The printer 10 comprises a housing 20 mounted to a frame 30, a supply holder 40, a platen roller 60, and printhead 50. As illustrated in FIG. 2, the printhead 50 comprises a dot line 52. Thermal printers utilize heat dots to create images on thermally sensitive media stock. The dot line 52 is a single line along which a plurality of heat dots is arranged. As illustrated in FIG. 3, the platen roller 60 comprises a center line 64.

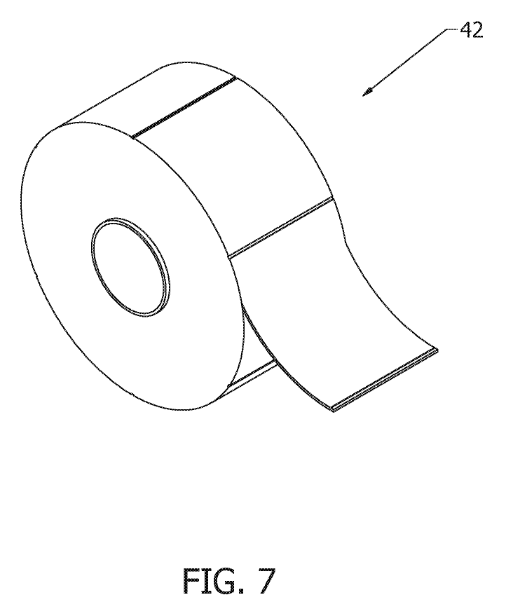

The printer 10 is operated by loading media, such as a receiver material 42 illustrated in FIG. 7, onto the supply holder 40 which is attached to the frame 30. The receiver material 42 is generally a roll of label stock, or similar media with a direct thermal coating or a thermal transfer ribbon, and may vary in thickness and stiffness. Typical receiver materials may range from five to eighteen millimeters in thickness, although the invention may accommodate thinner or thicker materials as desired. A second characteristic of the receiver material 42 is the supply stiffness which is measurable using an industry standard practice such as, but not limited to, the Gurley or Taber Stiffness tests.

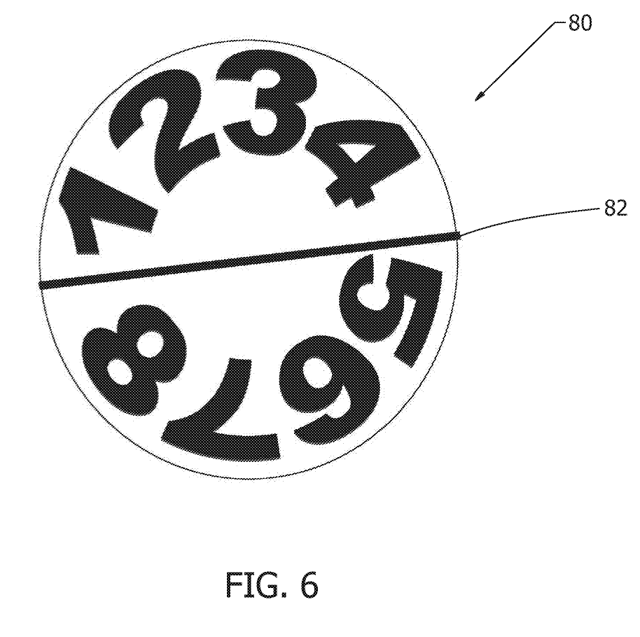

The printer 10 feeds the receiver material 42 between the printhead 50 and the platen roller 60. The platen roller 60 presses the receiver material 42 against the printhead 50; which is engaged and disengaged by a lever 70. The stiffness and thickness of the receiver material 42 impact an optimal location of the dot line 52 of the printhead 50 with respect to the center line 64 of the platen roller 60. The user must manually adjust the location to an optimal tangent point on the center line 64 of the platen roller 60 for each type of receiver material 42. With many adjustable printhead tangent points currently available in the market, is that the current printheads allow the user to misalign the dot line by having the left side and right side of the platen adjusted separately which often leads to poor print quality. The user operates a position indicator 80 comprising a center line 82, as illustrated in FIG. 6, to adjust the printhead 50 with respect to the platen roller 60 as described infra. The center line 82 indicates a nominal setting of the platen roller 60 and the dot line 52 based on a primary roll of the receiver material 42 intended for the printer 10. It is possible on different types of supply materials to recommend an optimal setting for the supply simplifying the setup for the operator. This setting can be communicated to the user via printed documentation such as, in one embodiment, a label inside supply core of roll 42 or accessible per a user accessible cloud database.

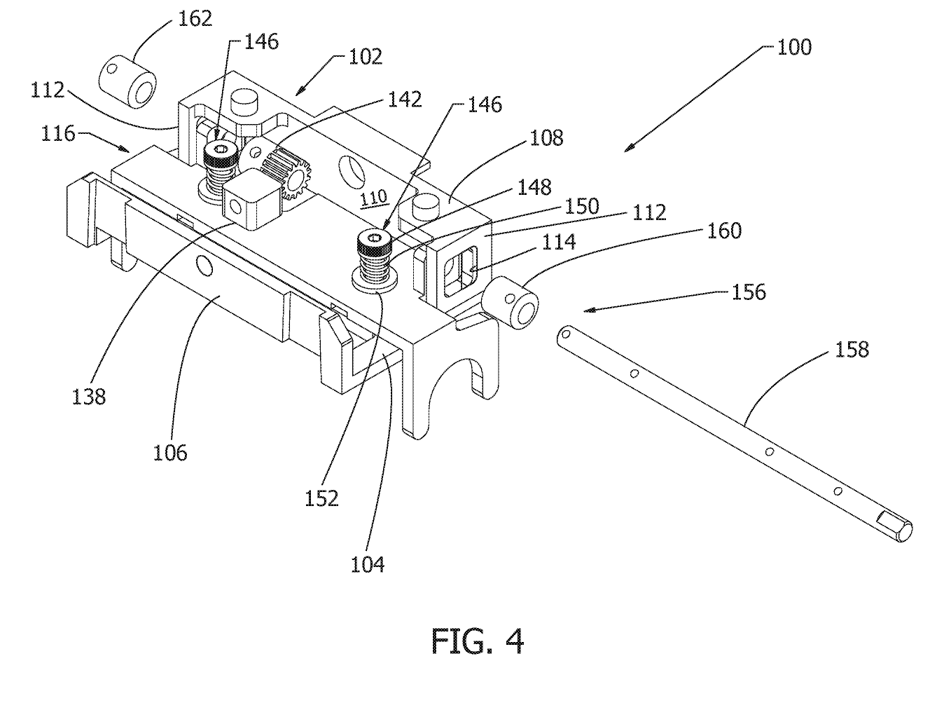

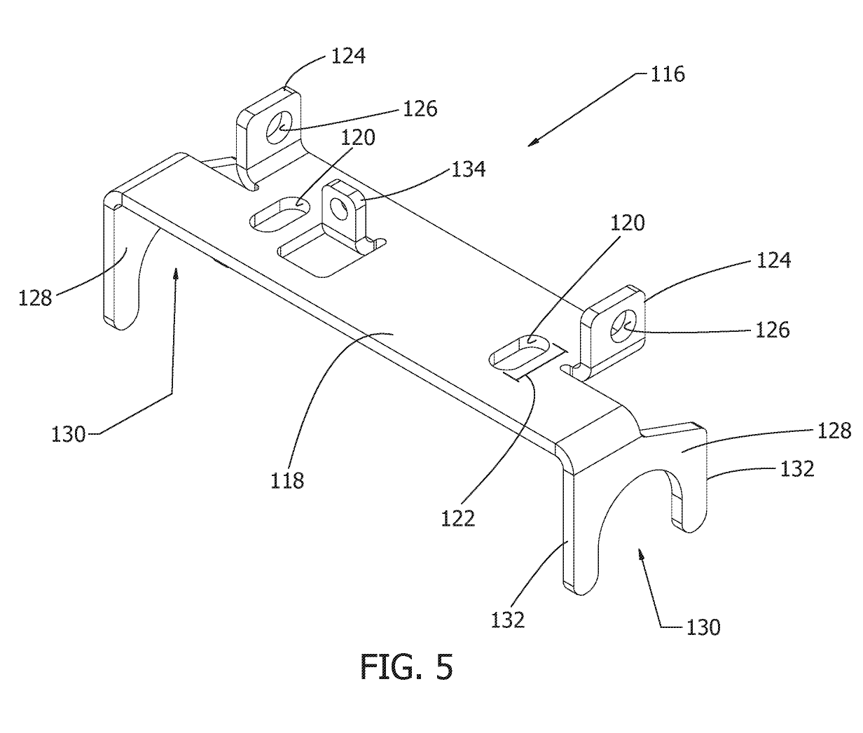

The printer 10 further comprises an assembly 100 for adjusting the printhead 50 with respect to the platen roller 60. FIG. 4 illustrates the assembly 100 for tangentially adjusting the printhead 50. The assembly 100 comprises a first bracket 102 and a second bracket 116 as illustrated in FIG. 5. The first bracket 102 comprises a base plate 104, a front component 106, and a rear component 108. The front component 106 extends approximately perpendicularly from the base plate 104 to define a vertical wall to which the printhead 50 is mounted. Typically, the printhead 50 snaps, latches, or is otherwise attached to the front component 106. The rear component 108 comprises a back wall 110 and a pair of side tabs 112. The back wall 110 extends approximately perpendicularly from the base plate 104 similarly to the front component 106. The pair of side tabs 112 extend inward toward the front component 106 approximately perpendicularly to the back wall 110. The pair of side tabs 112 each comprises a shaft opening 114.

The second bracket 116 comprises a first bracket engaging portion 118, a pair of flanges 124, and a pair of locating members 128. The first bracket engaging portion 118 is a plate comprising a pair of openings 120. Each opening 120 is a slot or cutout in the plate and is generally oval in shape 130. The pair of openings 120 mirror or are otherwise oriented substantially parallel to each other. Each opening 120 comprises a length 122 which defines the total adjustability allowable to the user in setting the dot line 52 adjustment. Providing the user with adjustability within a range of generally acceptable print quality prevents the user from adjusting the tangent point that may result in poor print quality to the extent the print may be non-legible.

Each flange 124 forms a flap or ear that extends upwards from and approximately perpendicularly to the first bracket engaging portion 118. When the second bracket 116 engages the first bracket 102, each flange 124 aligns with one of the pair of side tabs 112 of the first bracket 102. Each of the pair of flanges 124 comprises a hole 126 which generally aligns with the corresponding shaft opening 114 in the adjacent side tab 112. Each locating member 128 comprises a pair of guide walls 132 defining a channel 130. The guide walls 132 are substantially parallel to each other and receive and locate the platen roller 60 within each channel 130. The pair of guide walls 132 rotatably engage and support the platen roller 60 so that an axis of the platen roller 60, in one embodiment, is substantially parallel with the printhead 50 once the first bracket 102 and second bracket 116 are attached. The present invention also contemplates that an axis of the platen roller may be parallel or minimally parallel with the printhead 50. This prevents the misalignment of the head. Other mechanisms on the market do not include this feature, and, thus, this is one benefit of the present invention. The second bracket 116 further comprises a tab 134 located between the pair of openings 120. The tab 134 extends laterally from and substantially perpendicularly out of first bracket engaging portion 118.

The assembly 100 further comprises a positioning element 138, an adjusting element 142, and a camshaft 156. The positioning element 138 is attached to the tab 134 of the second bracket 116, and is preferably a ball plunger. However, any other positioning system such as, but not limited to, a pulley, a rod, a screw rod, a piston, and the like may be used as well. The adjusting element 142 is typically a gear that is engaged with the positioning element 138. However, any other adjusting system such as, but not limited to, a set screw, and the like may be used as well. The adjusting element 142 is rotated by the camshaft 156 to a location desired by the user indicated by adjusting the position indicator 80. As the camshaft 156 is rotated, the adjusting element 142 engages the positioning element 138 pushing the second bracket 116 across the first bracket 102, thereby adjusting the printhead 50 with respect to the platen roller 60.

The camshaft 156 comprises a shaft portion 158, a first cam 160, and a second cam 162. When the first bracket 102 and the second bracket 116 are attached, the shaft portion 158 runs through the pair of shaft openings 114 of the first bracket 102 and is rotatably retained by the pair of holes 126 in the pair of flanges 124 of the second bracket 116. The first cam 160 and the second cam 162 are located near the ends of the shaft portion 158 and move the first bracket 102 along the pair of locating members 128 of the second bracket 116 to adjust the dot line 52 to the center line 64 of the platen roller 60 while keeping the printhead 50 and platen roller 60 parallel or substantially parallel as the adjustment is made. The user turns an adjusting knob (not shown) to rotate the camshaft 156 to make an adjustment.

The assembly 100 further comprises a pair of securing members 146 for locking the second bracket 116 to the first bracket 102 once an adjustment is made. Each securing member 146 may comprise a fastener 148, a spring 150, and a spacer 152. Typically the fastener 148 is a shoulder screw or similar fastener that threads through the spring 148, and the spacer 152, such as a washer. Each securing member 146 penetrates one of the openings 120 in the second bracket 116 and seats into the base plate 104 of the first bracket 102 locking the brackets 102 and 116 together at that position. To reposition the brackets 102 and 116, the user slides the first bracket 102 under the second bracket 116 with the securing members 146 seated in the base plate 104 but loosened. The distance that the first bracket 102 can slide along the second bracket 116 is defined by the length 122 of the openings 120 in the second bracket 116. Once the proper adjustment between the printhead 50 and platen roller 60 is achieved, the securing members 146 are tightened, locking the brackets 102 and 116 together at that position. The adjustments are made without the need for any adjusting tools. The assembly 100 is useable by printheads with or without ink saving features.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A printer comprising:
a housing mounted to a frame;
a supply holder mounted to the frame for retaining a receiver material;
a platen roller;
a printhead; and
an assembly comprising a first bracket and a second bracket for retaining and adjusting the printhead with respect to the platen roller.

2. The printer of claim 1, wherein the first bracket adjustably engages the second bracket.

3. The printer of claim 2, wherein the first bracket engages the printhead.

4. The printer of claim 2, wherein the second bracket engages the platen roller.

5. An assembly for adjusting a printhead of a printer, the assembly comprising:
a first bracket;
a second bracket;
a positioning element attached to the second bracket; and
an adjusting element for engaging the positioning element to adjust the position of the first bracket with respect to the position of the second bracket.

6. The assembly of claim 5, further comprising a pair of securing members for locking the second bracket to the first bracket.

7. The assembly of claim 5, further comprising a camshaft.

8. The assembly of claim 5, wherein the first bracket comprises a base plate and a front component for engaging the printhead.

9. The assembly of claim 7, wherein the first bracket comprises a rear component for retaining the camshaft.

10. The assembly of claim 7, wherein the second bracket comprises a first bracket engaging portion comprising a pair of openings.

11. The assembly of claim 10, wherein each of the pair of openings comprises a length.

12. The assembly of claim 11, wherein each of the pair of openings is substantially oval in configuration and is oriented substantially parallel to the other of the pair of openings.

13. The assembly of claim 10, wherein the second bracket further comprises a pair of flanges extending perpendicularly from the first bracket engaging portion.

14. The assembly of claim 13, wherein each of the pair of flanges comprises an opening for retaining the camshaft.

15. An assembly for adjusting a printhead of a printer, the assembly comprising:
a first bracket;
a second bracket;
a positioning element attached to the second bracket;
an adjusting element for engaging the positioning element to adjust the position of the first bracket with respect to the position of the second bracket; and
a camshaft rotatably engaging the adjusting element.

16. The assembly of claim 15, further comprising a pair of securing members for adjustably locking the second bracket to the first bracket.

17. The assembly of claim 15, wherein the camshaft comprises a first cam and a second cam.

18. The assembly of claim 15, wherein the adjusting element engages the positioning element to slide the second bracket laterally across the first bracket.

19. The assembly of claim 18, wherein the second bracket comprises a pair of locating members for retaining a platen roller of the printer.

20. The assembly of claim 19, wherein rotating the camshaft adjusts the printhead with respect to the platen roller.
